(19) United States
(12) Patent Application Publication
(10) Pub. No.: US 2014/0278631 A1
(43) Pub. Date: Sep. 18, 2014

(54) SYSTEM AND METHOD FOR MANAGING BUSINESS FUNCTIONS FOR ONE OR MORE COMPANIES

(71) Applicant: RAM KARUPPUSAMY, HERNDON, VA (US)

(72) Inventor: RAM KARUPPUSAMY, HERNDON, VA (US)

(21) Appl. No.: 14/218,852

(22) Filed: Mar. 18, 2014

Related U.S. Application Data
(60) Provisional application No. 61/788,417, filed on Mar. 15, 2013.

(51) Int. Cl. G06Q 10/06

(52) U.S. Cl. CPC G06Q 10/06311; G06Q 10/06316
USPC 705/7.13

(57) ABSTRACT

Approaches for managing business functions for one or more companies are disclosed. In an implementation, business rules that enable a workflow to be initiated (e.g., without an explicit user request for the initiation of the workflow) upon detection of an event associated with at least one of the business rules may be stored. Responsive to detection of a first event, a first business rule of the business rules that is associated with the first event may be identified. A first workflow that comprises one or more tasks associated with the first business rule and a first entity may be initiated based on the first business rule. A first task of the one or more tasks may be assigned to a first user associated with the first entity.

### CROSS-REFERENCE TO RELATED APPLICATIONS

This application claims priority to: U.S. Provisional Patent Application Ser. No. 61/788,417, filed on Mar. 15, 2013, entitled, “SYSTEM AND METHOD FOR MANAGING BUSINESS FUNCTIONS FOR ONE OR MORE COMPANIES,” which is hereby incorporated by reference herein in its entirety.

### FIELD OF THE INVENTION

The invention relates to a system and method for managing business functions for one or more companies, for example, via a single shared data repository, including an ability to customize the business functions managed, provide customized workflows related to business rules associated with business functions, and provide customizable access to the data and documents related to the business functions.

### BACKGROUND OF THE INVENTION

Generally speaking, companies use numerous systems to manage various business functions, such as legal compliance, employee onboarding, accounting, human resource services, client and vendor management, and/or other business functions. These numerous systems may have disparate data sources, may not be able to communicate data or requirements with each other, and may suffer other such shortcomings. As such, managing the business functions for a company may involve accessing numerous systems, implementing complicated data management policies to ensure that the disparate data sources used for managing the business functions have the same data, and/or may involve other complex implementations.

Conventional business management tools may exist, but have various limitations and drawbacks. For example, conventional business management tools may be limited to providing functionality for a discrete, pre-determined number of business functions. Often, numerous conventional business management systems may be needed to facilitate the business functions needed by a single company. Further, numerous discrete data sources may be required for each disparate business management tool. These and other drawbacks exist.

### SUMMARY OF THE INVENTION

The disclosure relates to a system and method for managing business functions for one or more companies, for example, via a single shared data repository, including an ability to customize the business functions managed, provide customized workflows related to business rules associated with business functions, and provide customizable access to the data and documents related to the business functions.

According to an aspect of the invention, the system may provide a common application and set of user interfaces to facilitate the management of one or more workflows, one or more components, one or more templates, and/or other elements configured to facilitate management of one or more business functions for a company. For example, the common application may provide access to the set of user interfaces, where an individual user interface may relate to a component that facilitates management of a business function. The system may allow a company to customize the set of components to be managed via the system. For example, the system may allow a company to select existing components, customize existing components, create new components, and/or otherwise customize the set of components available via the common application for the company. The system may also allow a company to customize the set of workflows to be managed via the system. For example, the system may allow a company to select existing workflows, customize existing workflows, create new workflows, and/or otherwise customize the set of workflows available via the common application for the company.

As used herein, a business function may comprise, for example, a broad operation performed by a company. Business functions facilitated by the system may include one or more of managing clients, managing vendors, managing employees, onboarding new employees, managing projects, managing recruitment, managing sales, staffing, managing finances, managing accounts, providing human resource capabilities, managing payroll, managing information technology services, managing legal services, managing immigration, ensuring compliance, providing management overviews, reporting, providing individual overviews, providing company administration services, and/or other business functions related to managing a business.

As used herein, a workflow may relate to one or more business rules. A business rule may comprise, for example, one or more logical assertions associated with an entity, an operation, and/or data of the company. A workflow may also be associated with one or more entities of the company, such as one or more administrators, one or more clients, one or more vendors, one or more employees, one or more managers, one or more administrators, one or more in-house counsel, one or more human resources personnel, and/or other entities. As used herein, a component may facilitate interaction with one or more workflows related to an individual business function and may provide an overview of data, reports, and functionality related to the individual business function. As used herein, a template may comprise a customizable document for use in a workflow. A template may be created, edited, provided, and/or otherwise managed via the system.

The system, including the one or more workflows, one or more components and one or more templates, may access a shared repository of data. The shared repository of data may store data related to a plurality of business functions, may store a plurality of business rules associated with each of the business functions, may store information related to the one or more elements of the system, may store information related to performance and/or execution of the system, and/or may store other information related to the system. Data may be dynamically updated and populated in real-time across the various user interfaces.

As mentioned above, one or more workflows may enable functionality related to one or more business rules of a company and may be associated with one or more entities involved with the system. An individual workflow may comprise one or more tasks related to the one or more business rules. The one or more tasks of the workflow may be associated with a single business rule and/or may be associated with a plurality of business rules. The tasks may be set in order, with one or more tasks occurring in parallel, one or more tasks occurring serially, one or more tasks ordered after completion of one or more other tasks, and/or one or more tasks occurring in other orders. A task may comprise information related to a person, group, role, and/or other entity to which the task is assigned, a description of the task, one or more templates associated with the task, information indicating whether approval is needed by one or more entities, information indicating whether the task is contingent upon completion of one or more other tasks, a begin date, an end date, a time frame in which the task is to be completed, information indicating automated functions associated with the task (e.g., creation of a template, communication of a reminder relating to the task, communication of a request for approval, communication of a notification of the task, communication of a reminder related to one or more other tasks upon whose completion which the task is contingent, and/or other automated functions relating to the task), and/or other information related to a task.

The one or more tasks associated with the workflow may depend upon a type of the workflow. The system may include one or more types of workflows. A type of workflow may correspond to one or more business rules associated with a business function and stored in the shared data repository. For example, a type of workflow may comprise one or more pre-set tasks associated with the business rule. An individual workflow may be customized by including, revising, or deleting one or more tasks, providing one or more types of data and/or values of data for manipulation by the workflow, changing an order of one or more tasks, and/or otherwise changing the workflow. In some implementations, a customized workflow may be stored as a new workflow associated with the business rule.

A component associated with an individual business function may comprise a user interface dashboard that enables display of information related to the business function, one or more sub-components related to functionality associated with the business function, and/or other elements related to the individual business function. For example, for a specific business function, a user interface dashboard may display the workflows associated with that business function, relevant data associated with that business function, and/or other information related to the business function. A sub-component may be related to a particular functionality associated with the business function. The component may be customized with additional sub-functions, removal of one or more sub-components, addition, revision, or deletion of information displayed via the user interface dashboard, revision of a layout of the information displayed via the user interface dashboard, and/or other customization. A sub-component may comprise a sub-component user interface dashboard, one or more sub-sub-components, and/or other elements. The sub-component may comprise same or similar functionality as the component. In some implementations, the information displayed by the user interface dashboard and the sub-functions associated with the component may depend upon a type of the component. A type of component may correspond to type of business function.

As mentioned above, a template may comprise a customizable document for use in a workflow. A template may comprise pre-set text with one or more variables interspersed within the pre-set text. The variables may be associated with data associated in the shared data repository. When generating a form based on the template, data may be obtained related to the variables from the shared data repository and the variables interspersed within the pre-set text of the template may be replaced with the obtained data. For example, the variables may be related to a company logo, names of entities included in the document, and/or other information obtained from the shared data repository. The pre-set text and variables included in a template may depend upon a type of template. The system may include a variety of templates. For example, one or more types of template may include offer letters, invoices, debit notices, reminders, notifications, and/or other type of form letter. An individual template may be customized by including, revising, or deleting the pre-set text with the template, including, revising, or deleting the variables interspersed in the pre-set text, changing a layout of the text and variables, and/or otherwise changing the template. In some implementations, a customized template may be stored as a new template.

A system for business management may comprise a computing device including a physical processor configured to perform some or all of a functionality of a plurality of modules. In some implementations, the computing device may comprise a non-transitory, tangible computer-readable storage medium with an executable program stored thereon, wherein the program instructs a microprocessor to perform some or all of the functionality of the plurality of modules. The plurality of modules may include, for example, a company management module, a workflow management module, a component management module, a template management module, a reporting module, a role-based permissions module, and/or other modules. An administrator, manager, employee, client, vendor, counsel, human resources personnel, and/or other user may access the business management system via, for example, one or more interfaces (e.g., web pages) communicated from the computing device to a client device, an application such as a mobile application executing on a client device that generates the interface based on information communicated from the computing device, an agent running on the computing device, and/or via other interfaces.

A company management module may facilitate management of company-related information, restriction of access to system functionality and system information one or more workflows, one or more components, and/or other elements for one or more companies. The workflow management module may be configured to manage one or more workflows for a company, facilitate execution of one or more workflows, and/or perform other functionality related to managing workflows. The component management module may be configured to manage one or more components available for a company, manage one or more individual components, and/or perform other functionality related to managing components. The template management module may be configured to manage one or more templates, generate one or more documents based on one or more templates, and/or perform other functionality related to managing one or more templates. The reporting module may be configured to facilitate analysis and report information related to system usage, information related to workflows, components, templates, and/or other system elements, and/or other information stored via the system. The role-based permission module may be configured to tailor access to the system based on company-level access, one or more roles associated with a user of the system, and/or other parameters related to access of the system.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 is an exemplary illustration of a system for managing business functions for one or more companies via a single shared data repository, according to an aspect of the invention.

FIGS. 2-3 are exemplary illustrations of user interfaces that enable access to pending tasks associated with a user, according to aspects of the invention.

FIG. 4 is an exemplary illustration of a user interface that enables access to requested changes to employee information and a representation of a workflow initiated to facilitate the requested changes, according to an aspect of the invention.

FIG. 5 is an exemplary illustration of a user interface that enables access to tasks assigned to a user by a workflow scheduler, according to an aspect of the invention.

FIG. 6 is an exemplary illustration of a user interface that enables access to initiated workflows, pending workflows, and completed workflows, according to an aspect of the invention.

FIG. 7 is an exemplary illustration of a user interface that enables access to details of a workflow, according to an aspect of the invention.

FIG. 8 is an exemplary illustration of a user interface that enables access to details of a user, according to an aspect of the invention.

FIG. 9 is an exemplary illustration of a user interface that enables access to details of a community associated with a user, according to an aspect of the invention.

FIG. 10 is an exemplary illustration of a user interface that enables access to client-related features, according to an aspect of the invention.

FIG. 11 is an exemplary illustration of a user interface that enables access to vendor-related features, according to an aspect of the invention.

FIG. 12 is an exemplary illustration of a user interface that enables access to employee-related features, according to an aspect of the invention.

FIG. 13 is an exemplary illustration of a user interface that enables access to onboarding-related features, according to an aspect of the invention.

FIG. 14 is an exemplary illustration of a user interface that enables access to project-related features, according to an aspect of the invention.

FIG. 15 is an exemplary illustration of a user interface that enables access to sales-related features, according to an aspect of the invention.

FIG. 16 is an exemplary illustration of a user interface that enables access to features related to a book of accounts, according to an aspect of the invention.

FIG. 17 is an exemplary illustration of a user interface that enables access to human resource features, according to an aspect of the invention.

FIG. 18 is an exemplary illustration of a user interface that enables access to payroll-related features, according to an aspect of the invention.

FIG. 19 is an exemplary illustration of a user interface that enables access to information technology department features, according to an aspect of the invention.

FIG. 20 is an exemplary illustration of a user interface that enables access to legal department features, according to an aspect of the invention.

FIG. 21 is an exemplary illustration of a user interface that enables access to immigration-related features, according to an aspect of the invention.

FIG. 22 is an exemplary illustration of a user interface that enables access to compliance-related features, according to an aspect of the invention.

FIG. 23 is an exemplary illustration of a user interface that enables access to management-related features, according to an aspect of the invention.

FIG. 24 is an exemplary illustration of a user interface that enables access to report-related features, according to an aspect of the invention.

FIG. 25 is an exemplary illustration of a user interface that enables access to administrative features, according to an aspect of the invention.

FIG. 26 is an exemplary illustration of a flowchart of a method of managing business functions for one or more companies, according to an aspect of the invention.

FIG. 27 is an exemplary illustration of a flowchart of a method of facilitating completion of tasks of a workflow via notifications, according to an aspect of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

### Exemplary System Description

FIG. 1 is an exemplary illustration of a system 100 for managing business functions for one or more companies via a single shared data repository, according to an aspect of the invention. As shown in FIG. 1, system 100 may comprise server 102 (or servers 102). Server 102 may comprise company management module 106, workflow management module 108, component management module 110, template management module 112, reporting module 114, role-based permissions module 116, or other components.

System 100 may further comprise a user device 104 (or multiple user devices 104a-104n). User device 104 may comprise any type of mobile terminal, fixed terminal, or other device. By way of example, user device 104 may comprise a desktop computer, a notebook computer, a netbook computer, a tablet computer, a smartphone, a navigation device, an electronic book device, a gaming device, or other user device. Users may, for instance, utilize one or more user devices 104 to interact with server 102 or other components of system 100.

In some implementations, the various computers and subsystems illustrated in FIG. 1 may comprise one or more computing devices that are programmed to perform the functions described herein. The computing devices may include one or more electronic storages (e.g., electronic storage 118 or other electric storages), one or more physical processors programmed with one or more computer program instructions, and/or other components. The computing devices may include communication lines, or ports to enable the exchange of information with a network or other computing platforms. The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein of modules 106, 108, 110, 112, 114, 116, or other components. The processors may be programmed to execute computer program instructions by software; hardware; firmware; some combination of software, hardware, or firmware; and/or other mechanisms for configuring processing capabilities on the processors.

It should be appreciated that the description of the functionality provided by the different modules 106, 108, 110, 112, 114, or 116 described herein is for illustrative purposes, and is not intended to be limiting, as any of modules 106, 108, 110, 112, 114, or 116 may provide more or less functionality than is described. For example, one or more of modules 106, 108, 110, 112, 114, or 116 may be eliminated, and some or all of its functionality may be provided by other ones of modules 106, 108, 110, 112, 114, or 116. As another example, additional modules may be programmed to perform some or all of the functionality attributed herein to one of modules 106, 108, 110, 112, 114, or 116.

Attention will now be turned to a more detailed description of various implementations comprising one or more features relating to facilitating the presentation of content items, annotations associated with the content items, or other related items. It should be noted that features described herein may be implemented separately or in combination with one another.

### Company Management Module

The company management module 106 may facilitate management of one or more companies. For an individual company, the company management module 106 may facilitate the management of company-related information, management of company structure, restriction of access to system functionality and system information, management of one or more workflows, management of one or more components, management of one or more templates, and/or management of other elements related to an individual company.

The company management module 106 may be configured to manage company-related information for an individual company. The company related information may comprise, for example, a plurality of business rules associated with the company, an organization structure of the business functions of the company, an organization structure of the employees of the company, information related to employees of the company, information related to products and/or services of the company, information related to clients, vendors, and/or other entities involved in business relations with the company, information specific to the company (e.g., holidays, office locations, logos, and/or other company-specific information) and/or other information related to an individual company. In some implementations, the company management module 106 may facilitate the display of company-related information via a user interface. The display may be a textual display, a graphical display, and/or other type of display. The company management module 106 may be configured to facilitate addition, revision, deletion, and/or other management of company-related information via the user interface.

In some implementations, the company management module 106 may facilitate the display of information related to an organization structure of the plurality of employees for a company. For an individual employee, information related to a role of the employee, one or more groups associated with the employee, personal information related to the employee, one or more managers of the employee, and/or other information related to an employee may be accessed via a user interface. The company management module 106 may be configured to facilitate addition, revision, deletion, and/or other management of information related to the employees via the user interface. For example, the company management module 106 may be configured to facilitate a drag and drop of an employee from an existing position to a new position via the user interface. Responsive to a determination that an employee's position has been moved, the company management module 106 may automatically update information related to the employee.

In some implementations, the company management module 106 may be configured to restrict access to system functionality and information related to the system based on company-based permissions and role-based permissions for a user. The company-based permissions and role-based permissions may be set, for example, by the role-based permissions module.

The company management module 106 may be configured to manage one or more workflows for an individual company. An individual workflow may be related to one or more business rules associated with the company. In some implementations, the company management module 106 may facilitate the display of information related to one or more workflows associated with the company via a user interface. The company management module 106 may facilitate search, filter, ordering, and/or other manipulation of the information related to the one or more workflows. The company management module 106 may be configured to facilitate addition, revision, deletion, customization, and/or other management of one or more workflows via the user interface.

The company management module 106 may be configured to manage one or more components for an individual company. An individual component may be related to one or more business functions associated with the company. In some implementations, the company management module 106 may facilitate the display of information related to one or more components associated with the company via a user interface. The company management module 106 may facilitate search, filter, ordering, and/or other manipulation of the information related to the one or more components, related to one or more sub-components of the one or more components, and/or related to other information related to the one or more components. The company management module 106 may be configured to facilitate addition, revision, deletion, customization, and/or other management of one or more components and/or one or more sub-components via the user interface.

The company management module 106 may be configured to manage one or more templates for an individual company. An individual template may be related to a customizable document used with one or more workflows. In some implementations, the company management module 106 may facilitate the display of information related to one or more templates associated with the company via a user interface. The company management module 106 may facilitate search, filter, ordering, and/or other manipulation of the information related to the one or more templates. The company management module 106 may be configured to facilitate addition, revision, deletion, customization, and/or other management of one or more templates via the user interface.

### Workflow Management Module

The workflow management module 108 may be configured to manage one or more workflows for a company, facilitate execution of one or more workflows, and/or perform other functionality related to managing workflows.

The workflow management module 108 may be configured to facilitate selection of one or more workflows to be executed via the system 100 for the particular company. For example, one or more workflows may be available for execution via the system 100. As mentioned earlier, a workflow may relate to a business rule related to one or more entities associated with the system 100. An individual workflow may comprise one or more tasks related to the business rule and one or more entities involved with the company.

The one or more tasks of the workflow may be associated with a single business rule and/or may be associated with a plurality of business rules. The tasks may be set out in order, with one or more tasks occurring in parallel, one or more tasks occurring serially, one or more tasks occurring after completion of one or more other tasks, and/or one or more tasks occurring in other orders. The one or more tasks associated with the workflow may depend upon the type of the workflow. As mentioned above, a type of workflow may correspond to one or more business rules associated with a business function.

The workflow management module 108 may also facilitate the creation of a workflow related to a business rule. The workflow management module 108 may be configured to facilitate selection of one or more tasks related to a workflow, facilitate selection of an order of the one or more tasks, facilitate storage of information related to each of the one or more tasks, and/or facilitate storage of other information related to the workflow. For example, the workflow management module 108 may be configured to facilitate creation of a workflow based on a framework associated with a workflow. A framework for a workflow may comprise, for example, one or more tasks, an order of the one or more tasks, information related to the one or more tasks, and/or other elements of a workflow.

In some implementations, the creation of a workflow may comprise the creation and/or storage of a business rule. In some implementations, responsive to a determination that a new business rule has been stored with the system 100, a new workflow may be automatically created (and/or initiated) upon a trigger event associated with the business rule, an administrator may be prompted to create (and/or approve) a new workflow, and/or other functionality related to creating a new workflow may occur. In this way, the system 100 need not wait for explicit requests from administrators or other users to initiate specific workflows and/or assignments of tasks to specific users. In particular, in some implementations, the business rules may enable workflows to be initiated and/or their tasks to be assigned to users responsive to events associated with the business rules.

In some implementations, responsive to a determination that an existing workflow associated with a business rule has been customized, the existing workflow may be stored as a new workflow that is associated with the business rule.

The workflow management module 108 may also facilitate an association of one or more workflows with one or more manipulations of data via the system 100. For example, when a particular type of data is manipulated via the system 100, a business rule associated with the manipulation of data may be identified. Responsive to a determination that data has been manipulated, a workflow corresponding to the business rule may be initiated, a next task of the corresponding workflow may be initiated, and/or other execution of a corresponding workflow may occur. For example, if a client address is modified by a user, a business rule that requires approval from multiple supervisors for changes to client addresses may trigger a workflow that causes tasks requiring approvals to be assigned to the appropriate supervisors.

In some implementations, the workflow management module 108 may be configured to facilitate creation, revision, deletion, re-ordering of tasks, and/or other type of management of a workflow.

### Component Management Module

The component management module 110 may be configured to manage one or more components available for a company, manage one or more individual components, and/or perform other functionality related to managing components. In some implementations, the component management module 110 may comprise a company component management module, an individual component management module, and/or other modules.

Company Component Management Module

The company component management module may be configured to facilitate selection of one or more components to be accessed via the system 100 for the particular company. For example, one or more components may be available for management via the system 100. As mentioned earlier, a component may relate to a business function to be managed via the system 100. One or more existing components related to one or more business functions may include, for example, a client management component, a vendor management component, an employee management component, an onboarding component, a project management component, a recruitment management component, a sales management component, a finance component, an accounting component, a human resources component, a payroll component, an information technology (IT) component, an immigration component, a compliance component, a management component, an individual overview component, a company administration component, and/or other components related to other business functions. The company component management module may also facilitate the creation of a component related to a business function.

In some implementations, the company component management module may be configured to restrict access to one or more components based on a role-based permissions and company-based permissions of a user. In some implementations, the company component management module may be configured to restrict access to one or more sub-components of a component, one or more specific items of information displayed via a component and/or a sub-component, and/or other information and functionality based on role-based permissions and company-based permission of a user. For example, a management component may only be accessible to users who have permission to access the management component, whereas a client management module may be accessible to all users of the system 100.

In some implementations, the company component management module may be configured to facilitate creation, revision, deletion, and/or other type of management of a component. For example, the company component management module may be configured to facilitate creation of a component based on a framework associated with a component. For example, a framework for a component may comprise a user interface dashboard, one or more sub-components that facilitate functionality related to the business function associated with the component, and/or other elements of a component.

Individual Component Management Module

The individual component management module may be configured to manage a user interface dashboard for the component, facilitate management of sub-components of the component, and/or perform other functionality related to managing an individual component. In some implementations, the individual component management module may comprise a user interface dashboard management module, a sub-component management module, and/or other modules.

The dashboard management module may be configured to manage a user interface dashboard for the component. The user interface dashboard for the individual component may comprise a user interface via which one or more information groups related to the functionality associated with the component are displayed to a user of the system 100. An information group may comprise information related to one or more of a sub-component of the component, statistics related to the functionality, information related to the one or more workflows associated with the component, and/or other information related to the particular functionality associated with the component.

The dashboard management module may be configured to facilitate the selection of one of more information groups to display via the user interface dashboard. For the information groups selected, the dashboard management module may be configured facilitate customization of a layout for the display of the data related to the selected information groups. The dashboard management module may be configured to facilitate, for an individual information group, selection of one or more items of information to be included with the individual information group. For the items of information selected, the dashboard management module may be configured to facilitate customization of a layout of the selected items.

The dashboard management module may be configured to facilitate the display of the one or more information groups via one or more formats. For example, the dashboard management module may be configured to display the one or information groups via a text display, via a chart, via a display of trends, and/or via other formats. For the one or more formats, the dashboard management module may facilitate customization of the information displayed and the layout of the information displayed.

The sub-component module may be configured to manage one or more sub-components for the components, facilitate the functionality associated with the one or more sub-components, and/or perform other functionality related to the one or more sub-components for a component. For a component related to a particular business function, the component may comprise a pre-set group of one or more sub-components related to a respective one or more functionalities related to the particular business function. The sub-component module may be configured to facilitate selection of one or more sub-components for the component. The sub-component module may be configured to add one or more sub-components for the component, remove one or more sub-components from the pre-set group of sub-components, revise one or more sub-components for the component, and/or otherwise customize the sub-components for the component.

The sub-component module may be configured to facilitate the performance of functionality associated with the one or more sub-components. For example, for an individual sub-component, the sub-component module may be configured to facilitate display of one or more information groups related to the sub-component, facilitate user interaction with the sub-component, and/or otherwise facilitate the performance of functionality associated with the individual sub-component. User interaction with the sub-component module may comprise, for example, creation of new information related to the sub-component, revision of information related to the sub-component, deletion of information related to the sub-component, a search for information related to the sub-component, a filter of information displayed via the sub-component, and/or other interaction with the sub-component.

In some implementations, the sub-component module may manage associations between one or more workflows and one or more types of user interaction with the sub-components. User interaction with the sub-component may trigger execution of a workflow associated with the functionality of the sub-component. For example, when the user interaction is associated with a business rule (e.g., creation of new information related to the sub-component, revision of information related to the sub-component, deletion of information related to the sub-component, and/or other manipulation of information related to the sub-component), execution of a corresponding workflow may be triggered.

The sub-component module may comprise management of a user interface dashboard for an individual sub-component. The user interface dashboard for the individual sub-component may comprise a user interface via which one or more information groups related to the functionality associated with the sub-component are displayed to a user of the system 100. An information group may comprise information related to one or more of a sub-sub-component of the component, statistics related to the functionality, information related to the one or more workflows associated with the sub-component, and/or other information related to the particular functionality associated with the sub-component.

The sub-component module may be configured to facilitate the selection of one of more information groups for the sub-component to display via the user interface dashboard. For the information groups selected, the sub-component module may be configured facilitate customization of a layout for the display of the data related to the selected information groups. The sub-component module may be configured to facilitate, for an individual information group, selection of one or more items of information to be included with the individual information group. For the items of information selected, the sub-component module may be configured to facilitate customization of a layout of the selected items.

For example, a client management component may comprise a user interface dashboard and one or more sub-components. The user interface dashboard may display information related to one or more information groups. For example, the information groups for the client management component may include active clients, direct clients, indirect clients, top client issues, predetermined number of top clients by parameter (e.g., revenue, active contractors, employees, and/or other parameters), predetermined number of top clients per verticals, and/or other information groups. The one or more sub-components for the client management component may include a new client sub-component, a client list sub-component, a communication sub-component, end client sub-component, a reports sub-component, and/or other sub-components.

The new client sub-component may comprise functionality that facilitates creation, by a user, of a new client for an organization. The new client sub-component may facilitate display of a form via a user interface. The form may comprise with one or more interactive fields via which a user may enter information for the new client.

The client list sub-component may comprise functionality that facilitates display of an information group related to a client list. For example, the client list sub-component may facilitate display of one or more active clients, a list and count of active contractors associated with the respective one or more active clients, and/or other information related to clients of the company. The client list sub-component may facilitate the display of information related to an individual client, an individual contractor, status of a contract for a client, and/or other information related to an individual client. The client list sub-component may also facilitate a search for client information, filtering of client information displayed, and/or other user interaction with the client information.

The communication sub-component may comprise functionality that facilitates electronic communication via the client management component. For example, the communication sub-component may facilitate the sending of electronic communication related to information associated with the client management component. The electronic communication may comprise, for example, an email, a text message, an SMS, an internal system electronic message, and/or other electronic communication. The communication sub-component may also facilitate display, search, filtering, and/or other interaction with electronic communications related to the client management component.

The end client sub-component may comprise functionality that facilitates display of one or more end clients of the company. For example, the end client sub-component may facilitate display of one or more end clients, contacts related to one or more end clients, and/or other information related to end clients of the company. The end client sub-component may also facilitate a search for end client information, filtering of end client information displayed, and/or other user interaction with the end client information.

The reports sub-component may facilitate the generation, display, and/or other communication of one or more reports related to client information of the company. Reports may be automatically generated on a pre-determined time table. For example, the generation of reports may be tied to a workflow associated with the client management component.

### Template Management Module

The template management module 112 may be configured to manage one or more templates, generate one or more documents based on one or more templates, and/or perform other functionality related to managing one or more templates. As mentioned above, a template may comprise a customizable document for use in a workflow. A template may comprise pre-set text with one or more variables interspersed within the pre-set text. The variables may be associated with data associated in the shared data repository. When generating a form based on the template, the template management module 112 may obtain data related to the variables from the shared data repository and replace the variables interspersed within the pre-set text of the template with the obtained data. For example, the variables may be related to a company logo, names of entities included in the document, and/or other information obtained from the shared data repository. The template management module 112 may maintain one or more types of template including, for example, offer letters, invoices, debit notices, reminders, notifications, and/or other type of form letter. The specific template of a specific type used in a workflow may be determined by the workflow management module 108.

The template management module 112 may facilitate the creation, revision, deletion, customization, and/or other management of a template related to a workflow.

For example, the template management module 112 may be configured to facilitate creation of a template based on a framework associated with a template. For example, a A framework for a component may comprise pre-set text, one or more variables relating to data stored at the shared data repository, a layout of the pre-set text and the one or more variables, and/or other elements of a template.

For example, the template management module 112 may facilitate the display of the template via a user interface. One or more variables may be dragged and dropped into text displayed for the template via the user interface. One or more variables in the template may be removed by deleting the one or more variables, by dragging and dropping the variables outside of the template, and/or by other interactions with the one or more variables. In another example, the template management module 112 may facilitate the revision of the pre-set text associated with the template. In some implementations, the template management module 112 may facilitate the customization of a layout of the template.

In some implementations, the template management module 112 may facilitate the addition, revision, deletion, and/or other management of variables for inclusion in a template. A variable may be related to data values stored in the shared data repository. For example, when generating a document based on the template, the template management module 112 may run an SQL query to access the data associated with a variable in the template.

### Reporting Module

The reporting module 114 may be configured to facilitate analysis and report information related to system usage, information related to workflows, components, templates, and/or other system elements, system usage, user performance, and/or other information stored via the system 100.

### Role-Based Permissions Module

The role-based permission module may be configured to tailor a user's access to the system based company-level restrictions, employee-level restrictions, and/or other parameters related to access of the system 100. The role-based permission module may be configured to tailor a user's access to the system 100 based on one or more roles associated with the user. The role-based permissions module 116 may be configured to maintain one or more company-level roles upon which company-level restrictions may be based. The role-based permissions module 116 may maintain a plurality of company-level roles, including, for example, vendor, client, employee, and/or other roles. Company-level roles may grant access to various system features such as for example, access to one or more modules, access to information stored at a storage, and/or other access to system features. Different company-level roles may be granted that provide access to different system features.

When a user's company-level role is employee, the user may also have one or more employee-level roles. Employee-level roles may grant access to information related to a specific company. The role-based permissions module 116 may maintain a plurality of employee-level roles, including, for example, one or more types of manager, one or more types of employee, human resources personnel, finance employee, legal employee, and/or other roles. An employee-level role may be based upon a position of the user in the company. Different employee-based roles may be granted that provide access to different company information, provide access to different modules, and/or provide other access to the system.

In some implementations, the system 100 may facilitate the management of customized business functions for one or more companies. The system 100 may be used across various industries and for companies of different sizes. The functionality of the system 100 may be compatible with existing systems, may be integrated with one or more existing systems, or may be performed as a stand-alone system. For example, the system 100 may be integrated with multiple existing systems, such as, for example, external service provider systems, existing enterprise management systems, and/or other types of systems.

FIGS. 2-3 are exemplary illustrations of user interfaces 200 and 300 that enable access to pending tasks associated with a user, according to aspects of the invention. As shown, user interface 200 presents its listing of pending tasks based on task categories (e.g., employee, client, vendor, and IT), and user interface 300 presents its listing of pending tasks based on task assignees. Details associated with each pending task are also listed such as, “Assigned By,” “Assigned To,” “Create Date,” “Due Date,” etc. As depicted, users may have an option to group the list of pending tasks by task category, task assignor, task assignee, etc. A user may view the details of each pending task in a separate window, for example, by clicking on it. The user may approve, reject and close a particular task, etc. The user may schedule any pending task for approval/rejection.

FIG. 4 is an exemplary illustration of user interface 400 that enables access to requested changes to employee information and a representation of a workflow initiated to facilitate the requested changes, according to an aspect of the invention. As shown, the user may view requested changes and current details of a pending task.

FIG. 5 is an exemplary illustration of user interface 500 that enables access to tasks assigned to a user by a workflow scheduler, according to an aspect of the invention.

FIG. 6 is an exemplary illustration of user interface 600 that enables access to initiated workflows, pending workflows, and completed workflows, according to an aspect of the invention. A user may, for example, access approval details, requested changes, or other information associated with each task under a workflow via user interface 600 (e.g., by clicking on a depicted workflow). For example, FIG. 7 is an exemplary illustration of user interface 700 that enables access to details of a workflow, according to an aspect of the invention.

FIG. 8 is an exemplary illustration of user interface 800 that enables access to details of a user, according to an aspect of the invention. For example, a user may utilize user interface 800 to view and/or edit the user's personal details, job details, dependent details (e.g., children), emergency contact information, social media networks, benefits, payroll information, banking information, holidays, email settings, or other information.

FIG. 9 is an exemplary illustration of user interface 900 that enables access to details of a community associated with a user, according to an aspect of the invention. For example, a user may utilize user interface 900 to view and/or edit details of the user's external touch points, internal touch points, interest groups, protegee's, mentors, service providers, etc.

FIG. 10 is an exemplary illustration of user interface 1000 that enables access to client-related features, according to an aspect of the invention. For example, a user may utilize user interface 100 to view and/or edit active clients, direct/indirect clients, top client issues, top clients (e.g., with respect to revenue, active contractors, employees, etc.), or other client-related information.

FIG. 11 is an exemplary illustration of user interface 1100 that enables access to vendor-related features, according to an aspect of the invention. For example, a user may utilize user interface 1100 to view and/or edit top clients by vendors, top vendors by revenue, top clients by contractors, top clients by active vendors, top states by vendors, or other vendor-related information.

FIG. 12 is an exemplary illustration of user interface 1200 that enables access to employee-related features, according to an aspect of the invention. For example, a user may utilize user interface 1200 to view and/or edit Top 10 States by Employees, Top 10 Clients by Employees, Top 10 Vendors by Employees, Employee Visa Status and Event Reminders

FIG. 13 is an exemplary illustration of user interface 1300 that enables access to onboarding-related features, according to an aspect of the invention. For example, a user may utilize user interface 1300 to view, created, and/or edit internal onboarding documents for new joinees. A user may create a new document, a new template, or add additional documents to the existing onboarding documents.

FIG. 14 is an exemplary illustration of user interface 1400 that enables access to project-related features, according to an aspect of the invention. For example, a user may utilize user interface 1400 to view and/or edit details regarding resources, deliverables, invoices, project documents, request for proposal (RFP) documents (or bid documents), project workflows, etc., for each project.

FIG. 15 is an exemplary illustration of user interface 1500 that enables access to sales-related features, according to an aspect of the invention. For example, a user may utilize user interface 1500 to access information regarding sales applicants/candidates, sales requirements, job titles, interviews, call records, sales commissions, or other information.

FIG. 16 is an exemplary illustration of user interface 1600 that enables access to features related to a book of accounts, according to an aspect of the invention. For example, a user may utilize user interface 1600 to create and/or manage a book of accounts. A user may, for instance, manage accounts receivables and/or account payables with respect to the user's clients, vendors, subcontractors, etc. A user may pay outstanding bills, maintain journal entries, reconcile or maintain financial statements, manage trial balance, etc.

FIG. 17 is an exemplary illustration of user interface 1700 that enables access to human resource features, according to an aspect of the invention. For example, a user may utilize user interface 1700 to view and/or edit human resource information for analytical uses, such as Top 5 States by Employee count, Count of Employees at Direct Clients, head Count, Top Vertical by Employee, Dental Insurance Reports, Employee Count by Employment Category, Insurance Company Details, Enrollment Summary, Event Reminders, Health Insurance Details, etc.

FIG. 18 is an exemplary illustration of user interface 1800 that enables access to payroll-related features, according to an aspect of the invention. For example, a user may utilize user interface 1800 to manage payroll of employees at an organization.

FIG. 19 is an exemplary illustration of user interface 1900 that enables access to information technology department features, according to an aspect of the invention. For example, a user may utilize user interface 1900 to manage helpdesk requests, purchase requests, or other requests. A user may utilize user interface to view and/or edit software, hardware, mobiles, and other company assets, as well as details regarding vendors for IT procurement, billing and invoicing details of any IT/asset purchases.

FIG. 20 is an exemplary illustration of user interface 2000 that enables access to legal department features, according to an aspect of the invention. For example, a user may utilize user interface 2000 to view and/or edit details regarding active, inactive and terminated clients, number of active, inactive, and terminated employees, active inactive and terminated vendors, number of state registrations, number of active and inactive attorneys, or other information in a consolidated view.

FIG. 21 is an exemplary illustration of user interface 2100 that enables access to immigration-related features, according to an aspect of the invention. For example, a user may utilize user interface 2100 to view and/or edit various immigration data such as active H1Bs, new H1Bs in fiscal, Total H1bs, employee visa status, etc.

FIG. 22 is an exemplary illustration of user interface 2200 that enables access to compliance-related features, according to an aspect of the invention. For example, a user may utilize user interface 2200 to manage compliance with internal processes, such as employees, vendors, clients, finance, payroll, benefits, immigration, etc.

FIG. 23 is an exemplary illustration of user interface 2300 that enables access to management-related features, according to an aspect of the invention. For example, a user may utilize user interface 2300 to manage information regarding clients, vendors, employees, finances, human resources, legal, performance, compliance, or other information.

FIG. 24 is an exemplary illustration of user interface 2400 that enables access to report-related features, according to an aspect of the invention. For example, a user may utilize user interface 2400 to generate reports, such as client-specific reports, vendor-specific reports, employee-specific reports, ad-hoc reports, or other reports. Reports that can be generated may, for instance, include employee by status, client income, client bill rate change, total bill rate change by client, or other reports.

FIG. 25 is an exemplary illustration of user interface 2500 that enables access to administrative features, according to an aspect of the invention. For example, an administrative user may utilize user interface 2500 to manage user settings of other users, such as user details, user designations, user roles, user groups, or other settings.

### Exemplary Flowcharts

FIG. 26 is an exemplary illustration of a flowchart of a method of managing business functions for one or more companies, according to an aspect of the invention. The operations of method 2600 presented below are intended to be illustrative. In some implementations, method 2600 may be accomplished with one or more additional operations not described, and/or without one or more of the operations discussed. Additionally, the order in which the operations of method 2600 are illustrated in FIG. 26 and described below is not intended to be limiting.

In some implementations, method 2600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 2600 in response to instructions stored electronically on an electronic storage medium. The one or more processing devices may include one or more devices configured through hardware, firmware, and/or software to be specifically designed for execution of one or more of the operations of method 2600.

At an operation 2602, business rules may be stored (e.g., in a shared repository). The stored business rules may, for example, comprise business rules that enable a workflow to be initiated, without an explicit user request for the initiation of the workflow, upon detection of an event with at least one of the business rules. The stored business rules may comprise business rules related to a plurality of business functions of a business (or businesses). Operation 2602 may be performed by a company management module that is the same as or similar to company management module 106, in accordance with one or more implementations.

At an operation 2604, a first event may be detected. The first event may, for example, comprise a manipulation of data, a user interaction with a user interface, or other events. Operation 2604 may be performed by a workflow management module that is the same as or similar to workflow management module 108, in accordance with one or more implementations.

At an operation 2606, a first business rule of the stored business rules that is associated with the first event may be identified. The first business rule may, for example, comprise a business rule associated with a manipulation of a first type of data, a business rule associated with a first type of user interaction, or other business rule. Operation 2606 may be performed by a workflow management module that is the same as or similar to workflow management module 108, in accordance with one or more implementations.

At an operation 2608, the first workflow may be initiated based on the first business rule. The first workflow may, for example, be initiated without an explicit user request to initiate the first workflow. The first workflow may comprise one or more tasks associated with the first business rule and/or a first entity. The first entity may comprise a first group, a first role, a first user, or other entity. Operation 2608 may be performed by a workflow management module that is the same as or similar to workflow management module 108, in accordance with one or more implementations.

At an operation 2610, a first task (of the one or more tasks of the first workflow) may be assigned to the first user associated with the first entity. The first task may, for example, be assigned to the first user without an explicit user request to assign the first task to the first user. Operation 2610 may be performed by a workflow management module that is the same as or similar to workflow management module 108, in accordance with one or more implementations.

At an operation 2612, one or more other tasks of the first workflow may be assigned to one or more other users. Operation 2612 may be performed by a workflow management module that is the same as or similar to workflow management module 108, in accordance with one or more implementations.

At an operation 2614, notifications regarding the first and/or the other tasks may be provided to respective users. For example, notifications regarding the first and/or the other tasks may be provided to respective users based on whether the first and/or the other tasks have been completed. Operation 2614 may be performed by a workflow management module that is the same as or similar to workflow management module 108, in accordance with one or more implementations.

FIG. 27 is an exemplary illustration of a flowchart of a method of facilitating completion of tasks of a workflow via notifications, according to an aspect of the invention. The operations of method 2700 presented below are intended to be illustrative. In some implementations, method 2700 may be accomplished with one or more additional operations not described, and/or without one or more of the operations discussed. Additionally, the order in which the operations of method 2700 are illustrated in FIG. 27 and described below is not intended to be limiting.

In some implementations, method 2700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 2700 in response to instructions stored electronically on an electronic storage medium. The one or more processing devices may include one or more devices configured through hardware, firmware, and/or software to be specifically designed for execution of one or more of the operations of method 2700.

At an operation 2702, a first workflow may be initiated without an explicit user request for the first workflow. The first workflow may, for example, comprise tasks to be assigned to a first user and/or one or more other users. In an implementation, the first workflow may be initiated responsive to a first event associated with a first business event. Operation 2702 may be performed by a workflow management module that is the same as or similar to workflow management module 108, in accordance with one or more implementations.

At an operation 2704, a first task (of the tasks of the first workflow) may be assigned to the first user. Operation 2704 may be performed by a workflow management module that is the same as or similar to workflow management module 108, in accordance with one or more implementations.

At an operation 2706, other tasks (of the tasks of the first workflow) may be assigned to the one or more other users. Operation 2706 may be performed by a workflow management module that is the same as or similar to workflow management module 108, in accordance with one or more implementations.

At an operation 2708, a notification regarding a second task may be provided to a user (to which the second task is assigned). The notification regarding the second task may, for example, be provided responsive to a determination that the second task has not been completed. Operation 2708 may be performed by a workflow management module that is the same as or similar to workflow management module 108, in accordance with one or more implementations.

At an operation 2810, a notification regarding the first task may be provided to the first user. The notification regarding the first task may, for example, be provided to the first user responsive to a determination that the second task has been completed. In an implementation, for instance, completion of the first task may be contingent on completion of the second task. As such, the notification regarding the first task (e.g., that the first task is now available for the first user to complete, that information resulting from completion of the second task is now available for the first user to view to perform the first task, etc.) may be provided upon completion of the second task. In another implementation, the first user may not necessary need to wait until the second task is completed to perform/complete one or more sub-tasks of the first task. Operation 2810 may be performed by a workflow management module that is the same as or similar to workflow management module 108, in accordance with one or more implementations.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

1. A computer-implemented method of managing business functions for one or more companies, the method being implemented by a computer system that includes one or more physical processors executing one or more computer program instructions which, when executed, perform the method, the method comprising:
storing, by the computer system, business rules that enable a workflow to be initiated, without an explicit user request for the initiation of the workflow, upon detection of an event associated with at least one of the business rules;
detecting, by the computer system, a first event;
identifying, by the computer system, a first business rule of the business rules that is associated with the first event;
initiating, by the computer system, based on the first business rule, a first workflow that comprises one or more tasks associated with the first business rule and a first entity; and
assigning, by the computer system, a first task of the one or more tasks to a first user associated with the first entity.

2. The method of claim 1, wherein the first workflow is initiated without an explicit user request to initiate the first workflow.

3. The method of claim 1, wherein the first task is assigned to the first user without an explicit user request to assign the first task to the first user.

4. The method of claim 1, further comprising:
determining, by the computer system, whether a second task of the first workflow has been completed, wherein completion of the first task is contingent upon completion of the second task; and
providing, by the computer system, a notification regarding the second task to a user, to which the second task is assigned, responsive to a determination that the second task has not been completed.

5. The method of claim 4, further comprising:
providing, by the computer system, a notification regarding the first task to the first user responsive to a determination that the second task has been completed.

6. The method of claim 1, wherein the first event comprises a manipulation of a first type of data, and wherein identifying the first business rule comprises identifying a business rule associated with manipulation of data.

7. The method of claim 1, wherein the first event comprises a user interaction with a user interface.

8. The method of claim 1, wherein the first workflow comprises a plurality of tasks to be assigned to different entities.

9. The method of claim 1, wherein the first entity comprises at least one of a first group or a first role.

10. The method of claim 1, wherein the stored business rules comprises business rules related to a plurality of business functions of a business.

11. A system for managing business functions for one or more companies, the system comprising:
one or more physical processors programmed with one or more computer program instructions which, when executed, cause the one or more physical processors to:
store business rules that enable a workflow to be initiated, without an explicit user request for the initiation of the workflow, upon detection of an event associated with at least one of the business rules;
detect a first event;
identify a first business rule of the business rules that is associated with the first event;
initiate, based on the first business rule, a first workflow that comprises one or more tasks associated with the first business rule and a first entity; and
assign a first task of the one or more tasks to a first user associated with the first entity.

12. The system of claim 11, wherein the first workflow is initiated without an explicit user request to initiate the first workflow.

13. The system of claim 11, wherein the first task is assigned to the first user without an explicit user request to assign the first task to the first user.

14. The system of claim 11, further comprising:
determine whether a second task of the first workflow has been completed, wherein completion of the first task is contingent upon completion of the second task; and
provide a notification regarding the second task to a user, to which the second task is assigned, responsive to a determination that the second task has not been completed.

15. The system of claim 14, further comprising:
provide a notification regarding the first task to the first user responsive to a determination that the second task has been completed.

16. The system of claim 11, wherein the first event comprises a manipulation of a first type of data, and wherein identifying the first business rule comprises identifying a business rule associated with manipulation of data.

17. The system of claim 11, wherein the first event comprises a user interaction with a user interface.

18. The system of claim 11, wherein the first workflow comprises a plurality of tasks to be assigned to different entities.

19. The system of claim 11, wherein the first entity comprises at least one of a first group or a first role.

20. The system of claim 11, wherein the stored business rules comprises business rules related to a plurality of business functions of a business.
